(19) United States
(12) Patent Application Publication
(10) Pub. No.: US 2024/0028361 A1
(43) Pub. Date: Jan. 25, 2024

(54) VIRTUALIZED CACHE ALLOCATION IN A VIRTUALIZED COMPUTING SYSTEM

(71) Applicant: VMware, Inc., Palo Alto, CA (US)

(72) Inventors: Phani Kishore GADEPALLI, Cupertino, CA (US); Xunjia LU, Los Altos, CA (US); James Kenneth WHITE, Lake Stevens, WA (US); Sam SCALISE, San Jose, CA (US)

(21) Appl. No.: 17/869,680

(22) Filed: Jul. 20, 2022

(51) Int. Cl. G06F 9/455; G06F 12/084

(52) U.S. Cl. CPC G06F 9/45558; G06F 12/084; G06F 2009/45583; G06F 2212/152

(57) ABSTRACT

An example method of virtualized cache allocation for a virtualized computing system includes: providing, by a hypervisor for a virtual machine (VM), a virtual shared cache, the virtual shared cache backed by a physical shared cache of a processor; providing, by the hypervisor to the VM, virtual service classes and virtual service class bit masks; mapping, by the hypervisor, the virtual service classes to physical service classes of the processor; associating, by the hypervisor, a shift factor with the virtual service class bit masks with respect to physical service class bit masks of the processor; and configuring, by the hypervisor, service class registers and service class bit mask registers of the processor based on the mapping and the shift factor in response to configuration of the virtual shared cache by the VM.

### BACKGROUND

Computer virtualization is a technique that involves encapsulating a physical computing machine platform into virtual machine(s) executing under control of virtualization software on a hardware computing platform or “host.” A virtual machine (VM) provides virtual hardware abstractions for processor, memory, storage, and the like to a guest operating system. The virtualization software, also referred to as a “hypervisor,” incudes one or more virtual machine monitors (VMMs) to provide execution environment(s) for the virtual machine(s). As physical hosts have grown larger, with greater processor core counts and terabyte memory sizes, virtualization has become key to the economic utilization of available hardware.

Modern processors include quality of service (QoS) features that provide stronger control of shared resources for noisy neighbors. Noisy neighbors are applications that overutilize a shared resource in a manner that interferes with more important or latency-sensitive applications. For example, Intel Resource Director Technology (RDT) for x86 processors provides a set of QoS monitoring and resource control technologies, including Cache Allocation Technology (CAT). CAT is a QoS technology that allows operating systems or hypervisors to provide isolation of cache traffic on shared caches between applications or VMs running on processor cores and sockets. CAT can be used to allocate shared cache resources to classes of service (CLOS) and in turn to specific applications using those classes of service running on processor cores. Other types or processors include similar cache allocation technologies (e.g., AMD Cache Allocation Enforcement). CAT and like technologies are referred to herein as cache allocation systems.

Cache allocation systems are supported by the processor hardware and are configured through processor registers. In a virtualized computing system, the hypervisor can manage these processor registers for cache allocation control among its processes and threads. However, it is desirable to allow guest operating systems in VMs to also use cache allocation control to mitigate noisy neighbors among the applications executing in the VM. Thus, there is a need for the hypervisor to virtualize cache allocation systems of processors for use by guest operating systems in VMs.

### SUMMARY

In embodiments, a method of virtualized cache allocation for a virtualized computing system includes: providing, by a hypervisor for a virtual machine (VM), a virtual shared cache, the virtual shared cache backed by a physical shared cache of a processor; providing, by the hypervisor to the VM, virtual service classes and virtual service class bit masks; mapping, by the hypervisor, the virtual service classes to physical service classes of the processor; associating, by the hypervisor, a shift factor with the virtual service class bit masks with respect to physical service class bit masks of the processor; and configuring, by the hypervisor, service class registers and service class bit mask registers of the processor based on the mapping and the shift factor in response to configuration of the virtual shared cache by the VM.

Further embodiments include a computer system configured to carry out the above method(s). Though certain aspects are described with respect to VMs, they may be similarly applicable to other suitable physical and/or virtual computing instances.

### BRIEF DESCRIPTION OF THE DRAWINGS

FIG. 1 is a block diagram depicting a virtualized computing system according to an embodiment.

FIG. 2 is a block diagram depicting a CPU according to an embodiment.

FIG. 3 depicts tables illustrating bit mask configurations for virtual and physical service classes according to embodiments.

FIG. 4 is a block diagram depicting VMs configured to cache allocation according to embodiments.

FIG. 5 is a flow diagram depicting a method of virtualized cache allocation for a virtualized computing system according to embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

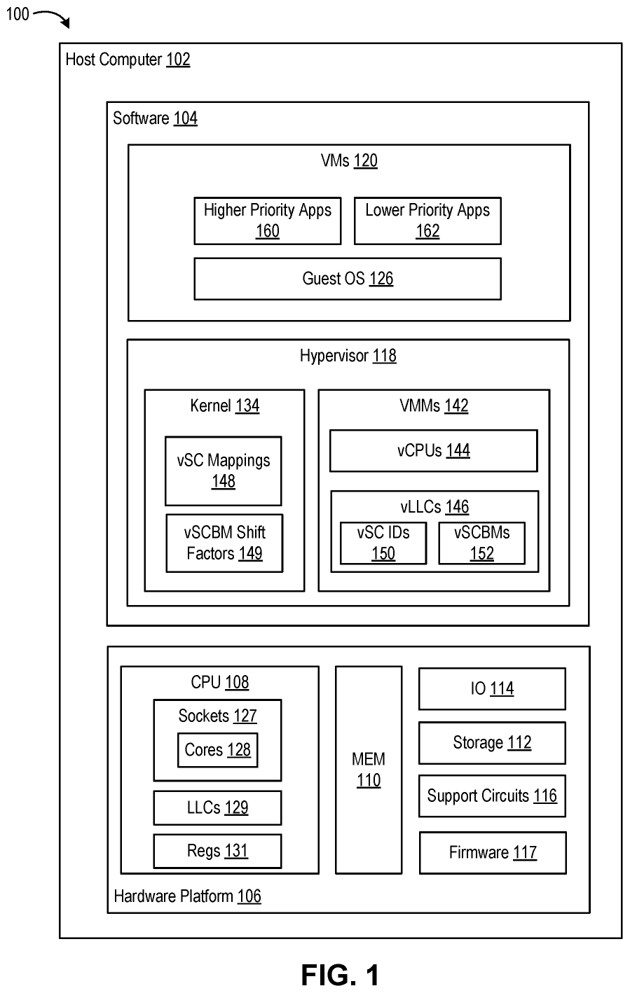

FIG. 1 is a block diagram depicting a virtualized computing system 100 according to an embodiment. Virtualized computing system 100 includes a host computer 102 having software 104 executing on a hardware platform 106. Hardware platform 106 may include conventional components of a computing device, such as a central processing unit (CPU) 108, system memory (MEM) 110, a storage system (storage) 112, input/output devices (TO) 114, and various support circuits 116. CPU 108 is configured to execute instructions, for example, executable instructions that perform one or more operations described herein and may be stored in system memory 110 and storage system 112. System memory 110 is a device allowing information, such as executable instructions, virtual disks, configurations, and other data, to be stored and retrieved. System memory 110 may include, for example, one or more random access memory (RAM) modules. Storage system 112 includes local storage devices (e.g., one or more hard disks, flash memory modules, solid state disks, and optical disks) and/or a storage interface that enables host computer 102 to communicate with one or more network data storage systems. Examples of a storage interface are a host bus adapter (HBA) that couples host computer 102 to one or more storage arrays, such as a storage area network (SAN) or a network-attached storage (NAS), as well as other network data storage systems. Storage 112 in multiple hosts 102 can be aggregated and provisioned as part of shared storage accessible through a physical network (not shown). Input/output devices 114 include conventional interfaces known in the art, such as one or more network interfaces. Support circuits 116 include conventional cache, power supplies, clock circuits, data registers, and the like. Firmware 117 controls initialization of hardware platform 106 and handoff of execution to hypervisor 118 upon power on of host computer 102.

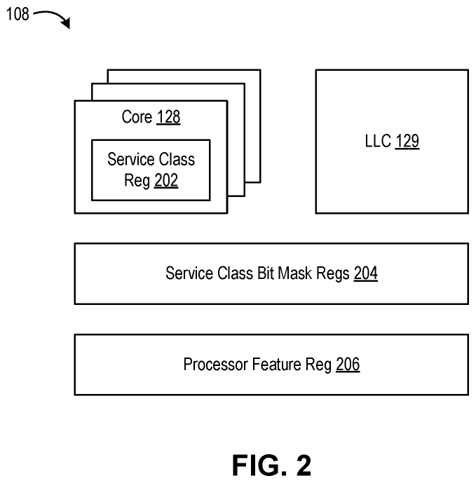

CPU 108 includes one or more sockets 127, each of which includes one or more cores 128 (among other components not shown for simplicity). Each core 128 is a microprocessor, such as an x86 processor or the like. Each socket 127 is associated with a shared cache referred to herein as a last level cache (LLC) 129. Cores 128 in a socket 127 share an LLC 129. LLCs 129 may be part of a cache hierarchy, for example, can be a 3^{rd} level shared cache where each core 128 has local 1^{st} and 2^{nd} level caches. Although the shared caches described herein are LLCs, it is to be understood that a processor can provide cache allocation control for any shared cache, including a shared cache at a level other than the last level. Sockets 127 can be part of one or more non-uniform memory access (NUMA) domains, e.g., one socket per NUMA domain. In such case, there is one LLC 129 per NUMA domain. However, for other types of processors, an LLC 129 can be shared across multiple NUMA domains. CPU 108 includes registers (regs 131), including registers for implementing cache allocation control (shown in FIG. 2).

Software 104 includes a virtualization layer that abstracts processor, memory, storage, and networking resources of hardware platform 106 into one or more virtual machines (“VMs”) that run concurrently on host computer 102. The VMs run on top of the virtualization layer, referred to herein as a hypervisor, which enables sharing of the hardware resources by the VMs. In the example shown, software 104 includes a hypervisor 118 that supports VMs 120. Hypervisor 118 includes a kernel 134 and virtual machine monitors (VMMs) 142 (among other components omitted for clarity). Kernel 134 provides operating system functionality (e.g., process creation and control, file system, process threads, etc.), as well as CPU scheduling and memory scheduling across guest software in VMs 120, VMMs 142, and other hypervisor processes. VMMs 142 implement the virtual system support needed to coordinate operations between hypervisor 118 and VMs 120. Each VMM 142 manages a corresponding virtual hardware platform that includes emulated hardware, including virtual CPUs (vCPUs 144) guest physical memory (also referred to as VM memory, not shown), and virtual LLCs (vLLCs 146). Each virtual hardware platform supports the installation of guest software in a corresponding VM 120. LLCs 129 may be referred to herein as physical LLCs (pLLCs) to distinguish from vLLCs 146.

Each VM 120 includes guest software (also referred to as guest code) that runs on the virtualized resources supported by hardware platform 106. In the example shown, the guest software of VM 120 includes a guest OS 126 and applications. The applications include higher priority applications 160 and lower priority applications 162. Guest OS 126 can be any commodity operating system known in the art (e.g., Linux®, Windows®, etc.). Applications 128/129 can be any applications executing on guest OS 126 within VM 120.

In embodiments, the cache allocation system of CPU 108 provides a service class abstraction that enables associating different service classes (e.g., based on priority/importance) to different workloads using shared cache. For example, Intel's CAT provides a class of service abstraction (COS or CLOS). Service classes can be used to group cores 128 into classes, which can then be allocated certain portions of an LLC 129 (e.g., a certain number of cache ways). CPU 108 can include a bit mask for each service class to specify how much cache is allocated to that service class (“service class bit mask”). For example, Intel's CAT provides a class bit mask for each CLOS. When bits in the service class bit mask are set (e.g., ‘1’), the associated portions of an LLC 129 are allocated to the corresponding service class. When bits in a service class bit mask are unset (e.g., ‘0’), the associated portions of an LLC 129 are not allocated to the corresponding service class. In embodiments, CPU 108 requires that the bits set in a service class bit mask be a contiguous string of bits. The cache allocations defined by the service class bit masks can overlap for multiple service classes, resulting in service classes that share portion(s) of an LLC 129. Example service classes and service class bit masks are described below.

FIG. 2 is a block diagram depicting CPU 108 according to an embodiment. In the embodiment, CPU 108 includes a single socket 127 having a plurality of cores 128 that share an LLC 129. CPU 108 includes a processor feature register 206 that describes various features of CPU 108, including a number of supported service classes and a number of valid bits in a service class bit mask. CPU 108 includes a plurality of service class bit mask registers 204, one for each service class. CPU 108 includes a set of service class bit mask registers 204 per LLC 129. Each core 128 includes a service class register 202 associated therewith. Software (e.g., hypervisor 118) can write a service class identifier (ID) to service class register 202 of a core 128 to associate thread(s) executing thereon to a particular service class (e.g., at context switch). Software (e.g., hypervisor 118) can write to service class bit mask registers 204 to allocate portion(s) of LLC 129 for use with each service class. In embodiments, each bit of a service class bit mask register 204 can allocate a service class to one or more ways of LLC 129. For example, LLC 129 can be a 16-way set-associative cache and each service class bit mask can be 8 bits. In such case, each bit of a service class bit mask allocates two ways of LLC 129 to a corresponding service class.

Returning to FIG. 1, hypervisor 118 virtualizes cache allocation control of CPU 108 for VMs 120 by virtualizing access to service class registers 202 and service class bit mask registers 204. To virtualize cache allocation control, hypervisor 118 exposes a vLLC 146 to a VM 120. As described further below, a vLLC 146 is backed by an LLC 129. Hypervisor 118 allocates vCPUs 144 to a VM 120 that are backed by pCPUs (e.g., cores 128) that share the same pLLC (e.g., LLC 129 backing vLLC 146). Hypervisor 118 exposes a set of virtual service classes and virtual service class bitmasks to VM 120. Each virtual service class includes a virtual service class (SC) ID (vSC IDs 150). Each virtual service class has an associated virtual service class bit mask (SCBM) (vSCBMs 152).

The number of virtual service masks exposed to VM 120 can range between zero and the maximum number of service classes supported by CPU 108. Hypervisor 118 maintains vSC mappings 148 to map virtual service classes to physical service classes of CPU 108 (e.g., vSC IDs to service class IDs). For example, vSCs 0, 1, and 2 for one VM 120 can be mapped to service class IDs 1, 2 and 3, while vSCs 0, 1, and 2 for another VM 120 can be mapped to service class IDs 4, 5, and 6. In embodiments, service class ID 0 is a default service class used by CPU 108, firmware 117, and other hypervisor processes and is not mapped to any virtual service class used by VMs 120. In embodiments, for VMs leveraging cache allocation control and having their vLLCs 146 mapped to the same LLC 129, hypervisor 118 can map their vSC IDs 150 to different service classes of the pLLC. This ensures cache access isolation among the VMs sharing the same LLC 129. Guest OS 126 in a VM 120 can then set vSCBMs 152 and assign vSC IDs 150 among its applications (e.g., to mitigate noisy neighbors).

In embodiments, each vSCBM 152 has a bit count between zero and one less than the maximum bit count of the physical bit masks associated with the pLLC. The bits of a vSCBM 152 are mapped to bit locations of a service class bit mask according to a shift factor maintained by hypervisor 118 (vSCBM shift factors 149). For example, a vSCBM 152 for vSC ID 0 with a bit count of three (bits 0-2) can be mapped to a set of contiguous bits in a service class bit mask (e.g., bits 4-6) for a service class mapped to vSC ID 0 (e.g., a shift factor of 4 bits).

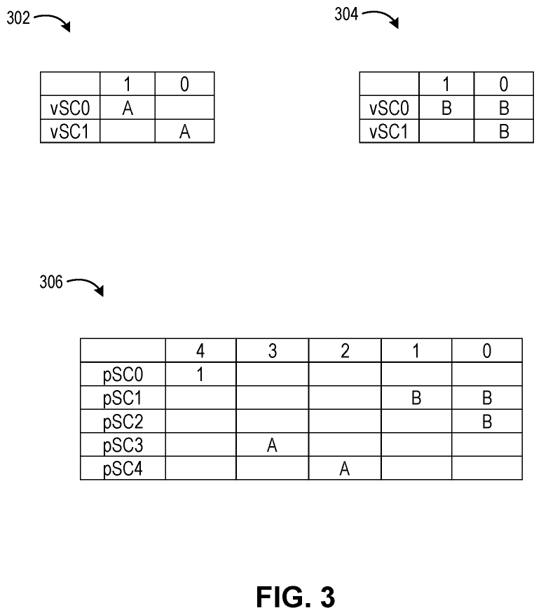

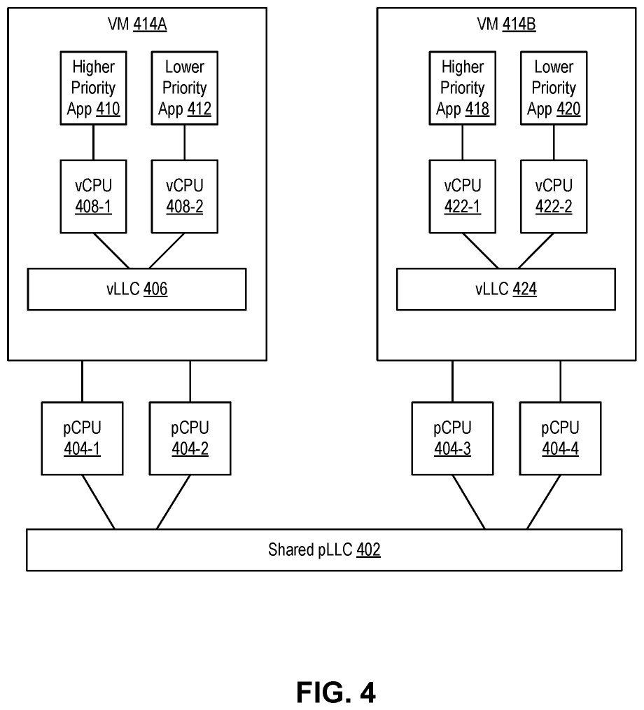

FIG. 3 depicts tables illustrating bit mask configurations for virtual and physical service classes according to embodiments. FIG. 4 is a block diagram depicting VMs configured to cache allocation according to embodiments. Referring to FIGS. 3 and 4, tables 302 and 304 show example virtual service class bit masks set by guest operating systems in two VMs 414A and 414B, respectively. In the example, hypervisor 118 configures each VM with two virtual service classes and virtual service class bit masks having a bit count of two. Note that this example is simplified and the virtual service bit masks can have a higher bit count for more granularity. Hypervisor 118 allocates vCPUs 408-1 and 408-2 to VM 414A, along with vLLC 406. Hypervisor 118 allocates vCPUs 422-1 and 422-2 to VM 414B, along with vLLC 424. Hypervisor 118 schedules vCPUs 408-1 and 408-2 on pCPUs 404-1 and 404-2, respectively. Hypervisor 118 schedules vCPUs 422-1 and 422-2 on pCPUs 404-3 and 404-4, respectively. In this example, pCPUs 404 use shared pLLC 402 and each of vLLCs 406 and 424 are backed by shared pLLC 402. VM 414A includes a higher priority application 410 executing on vCPU 408-1 and a lower priority application 412 executing on vCPU 408-2. VM 414B includes a higher priority application 418 executing on vCPU 422-1 and a lower priority application 420 executing on vCPU 422-2.

For VM 414A, the guest operating system sets up an isolated bit mask configuration where each virtual service class has its own portion of vLLC 406 isolated from other virtual service classes. The designation A in tables 302 and 306 indicates the bit is set for VM 414A. Empty boxes in tables 302, 304, and 306 indicate unset bits. As shown in table 302, the virtual service class vSC0 is allocated a portion of vLLC 406 corresponding to mask bit 1 and the virtual service class vSC1 is allocated a portion of vLLC 406 corresponding to mask bit 0. In the example, hypervisor 118 maps vSC0 for VM 414A to physical service class pSC3 and vSC1 for VM 414A to physical service class pSC4. Further, hypervisor 118 implements a bit shift factor of 2 for the virtual service class bit masks of VM 414A. Thus, the virtual service class bit masks for VM 414A are located in physical mask bits 2 and 3.

For VM 414B, the guest operating system sets up an overlapped bit mask configuration where the vSC0 virtual service class can access all of vLLC 424, the vSC1 service class can access only half of vLLC 424. The designation B in tables 304 and 306 indicates the bit is set for VM 414B. As shown in table 304, the virtual service class vSC0 is allocated to all of vLLC 424 corresponding to mask bits 0 and 1. The virtual service class vSC1 is allocated a portion of vLLC 424 corresponding to mask bit 0. In the example, hypervisor 118 maps vSC0 for VM 414B to physical service class pSC1 and vSC1 for VM 414B to physical service class pSC2. Further, hypervisor 118 implements a bit shift factor of 0 for the virtual service class bit masks of VM 414B. Thus, the virtual service class bit masks for VM 414B are located in physical mask bits 0 and 1.

In this example, it is assumed VMs 414A and 414B have vCPUs that are backed by pCPUs sharing the same pLLC (e.g., vLLCs for VMs 414A and 414B are backed by the same pLLC). The result is the vLLC for VM 414A uses the portion of the pLLC corresponding to bits 2-3 of the physical bit mask, and the vLLC for VM 414B uses the portion of the pLLC corresponding to bits 0-1 of the physical bit mask. The guest operating systems of VMs 414A and 414B can further partition these respective portions of the pLLC among their virtual service classes, e.g., for prioritizing applications.

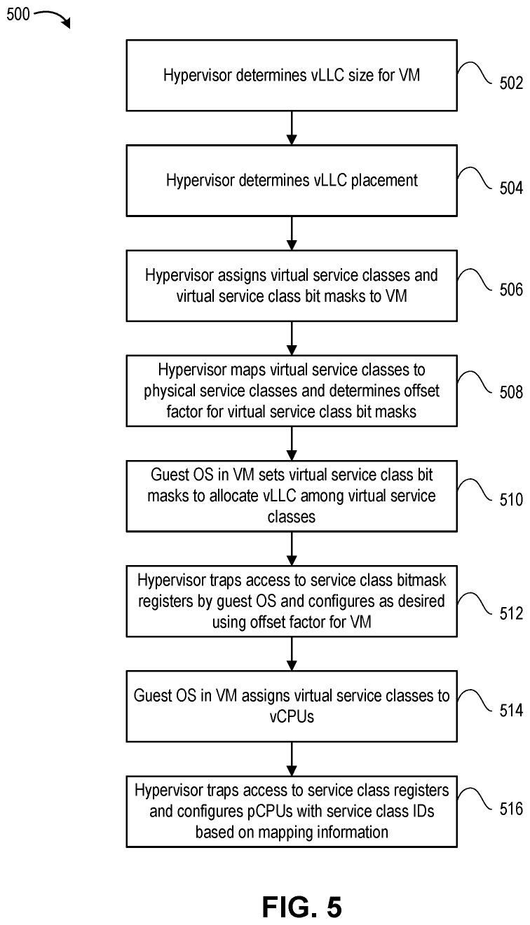

FIG. 5 is a flow diagram depicting a method 500 of virtualized cache allocation for a virtualized computing system according to embodiments. Method 500 begins at step 502, where hypervisor 118 determines a vLLC size for a VM 120. The vLLC size of a VM can be determined based on a number of vCPUs per virtual socket, for example. Traditionally, the vCPUs of a VM are allowed to share the physical LLCs and straddle across these LLCs allowing greater flexibility for the hypervisor to schedule vCPUs from different VMs. However, for VMs that leverage cache allocation features, vCPUs belonging to a single vLLC are not allowed to straddle across multiple physical LLCs, as the QoS resources being virtualized are inherently per physical LLC resources.

At step 504, hypervisor 118 determines vLLC placement with respect to physical LLCs. In an embodiment, hypervisor 118 determines vLLC placement based on static pCPU pinning information of the VM (which can be configured manually in its configuration file). Based on the vLLC size (step 502) and the static pinning of vCPUs for each vLLC, hypervisor 118 can determine physical placement and allocate QoS resources for virtualizing the cache allocation system. The static pinning configuration can either be 1:1, specifying a single vCPU to single pCPU, or the pinning can be a single vCPU to a range of pCPUs such that the superset of all pCPUs belonging to a single vLLC are on a single physical LLC boundary. In other embodiments, hypervisor 118 can determine vLLC placement on a physical LLC based on the physical NUMA placement of a VM statically specified through pinning or the physical home NUMA node placement of a VM determined by the hypervisor upon powering on a VM for which the placement does not change after power on. However, on hosts with each NUMA sharing multiple LLCs, the NUMA placement information alone will be insufficient to determine vLLC placement and therefore requires vCPU pinning as described above.

At step 506, hypervisor assigns virtual service classes and virtual service class bit masks to the VM. The number of virtual service classes is limited by the maximum number of physical service classes and the bit count of the virtual masks is limited to one less than the maximum bit count of the physical masks. At step 508, hypervisor 118 maps virtual service classes to physical service classes and determines the offset factor for the virtual service class bit masks. This information is stored in vSC mappings 148 and vSCBM shift factors 149 for the VM.

At step 510, guest OS 126 in VM 120 sets virtual service class bit masks to allocate vLLC among the virtual service classes. Guest OS 126 attempts to write to the service class bit mask registers 204 for the vSC IDs of the corresponding virtual service classes. However, hypervisor 118 traps guest accesses to service class bit mask registers 204, as discussed below.

At step 512, hypervisor 118 traps guest access to service class bit mask registers 204 and configures as dictated by the guest OS but using the offset factor to relocate the bit masks to match the physical bit mask allocation of a VM. At step 514, guest OS 126 in VM 120 assigns virtual service classes to its vCPUs. Guest OS 126 attempts to write to the service class registers 202, but such accesses are trapped by hypervisor 118. At step 516, hypervisor 118 traps guest access to service class registers 202 and configures pCPUs with service class IDs based on vSC mappings 148 (e.g., vSC IDs are mapped to physical SC IDs, which are written to service class registers 202). Notably, guest OS 126 is free to assign the service classes to its threads/processes in addition to its vCPUs. If the guest OS assigns service classes to threads/processes, and if the hypervisor traps on each context switch, this could affect guest OS performance. Thus, in embodiments, the hypervisor only traps when guest OS 126 assigns service classes to vCPUs. In other embodiments, guest programming of service class bit mask registers for threads/processes can be paravirtualized to improve the performance of context switches without hypervisor intervention.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of virtualized cache allocation for a virtualized computing system, comprising:
providing, by a hypervisor for a virtual machine (VM), a virtual shared cache, the virtual shared cache backed by a physical shared cache of a processor;
providing, by the hypervisor to the VM, virtual service classes and virtual service class bit masks;
mapping, by the hypervisor, the virtual service classes to physical service classes of the processor;
associating, by the hypervisor, a shift factor with the virtual service class bit masks with respect to physical service class bit masks of the processor; and
configuring, by the hypervisor, service class registers and service class bit mask registers of the processor based on the mapping and the shift factor in response to configuration of the virtual shared cache by the VM.

2. The method of claim 1, wherein the step of configuring comprises:
trapping, by the hypervisor, access to the service class bit mask registers by the VM; and
trapping, by the hypervisor, access to the service class registers by the VM.

3. The method of claim 1, further comprising:
determining, by the hypervisor, a size of the virtual shared cache for the VM based on a number of virtual central processing units (vCPUs) allocated to the VM.

4. The method of claim 3, further comprising:
placing, by the hypervisor, the virtual shared cache on the physical shared cache based on pinnings of the vCPUs to physical CPUs (pCPUs) of the processor.

5. The method of claim 3, further comprising:
placing, by the hypervisor, the virtual shared cache on the physical shared cache based on nonuniform memory access (NUMA) domains of the processor.

6. The method of claim 1, wherein the configuration of the virtual shared cache by the VM includes configuration of the virtual service class bit masks among the virtual service classes.

7. The method of claim 1, wherein the step of configuring comprises:
paravirtualizing access to the service class bit mask registers and the service class registers by the VM.

8. A non-transitory computer readable medium comprising instructions to be executed in a computer system to carry out a method of virtualized cache allocation for a virtualized computing system, comprising:
providing, by a hypervisor for a virtual machine (VM), a virtual shared cache, the virtual shared cache backed by a physical shared cache of a processor;
providing, by the hypervisor to the VM, virtual service classes and virtual service class bit masks;
mapping, by the hypervisor, the virtual service classes to physical service classes of the processor;
associating, by the hypervisor, a shift factor with the virtual service class bit masks with respect to physical service class bit masks of the processor; and
configuring, by the hypervisor, service class registers and service class bit mask registers of the processor based on the mapping and the shift factor in response to configuration of the virtual shared cache by the VM.

9. The non-transitory computer readable medium of claim 8, wherein the step of configuring comprises:
trapping, by the hypervisor, access to the service class bit mask registers by the VM; and
trapping, by the hypervisor, access to the service class registers by the VM.

10. The non-transitory computer readable medium of claim 8, further comprising:
determining, by the hypervisor, a size of the virtual shared cache for the VM based on a number of virtual central processing units (vCPUs) allocated to the VM.

11. The non-transitory computer readable medium of claim 10, further comprising:
placing, by the hypervisor, the virtual shared cache on the physical shared cache based on pinnings of the vCPUs to physical CPUs (pCPUs) of the processor.

12. The non-transitory computer readable medium of claim 10, further comprising:
placing, by the hypervisor, the virtual shared cache on the physical shared cache based on nonuniform memory access (NUMA) domains of the processor.

13. The non-transitory computer readable medium of claim 8, wherein the configuration of the virtual shared cache by the VM includes configuration of the virtual service class bit masks among the virtual service classes.

14. The non-transitory computer readable medium of claim 8, wherein the physical shared cache comprises a physical last level cache (LLC) of the processor.

15. A virtualized computer system, comprising:
a hardware platform including a processor; and
software executing on the hardware platform, the software configured to:
provide, by a hypervisor for a virtual machine (VM), a virtual shared cache, the virtual shared cache backed by a physical shared cache of the processor;
provide, by the hypervisor to the VM, virtual service classes and virtual service class bit masks;
map, by the hypervisor, the virtual service classes to physical service classes of the processor;
associate, by the hypervisor, a shift factor with the virtual service class bit masks with respect to physical service class bit masks of the processor; and
configure, by the hypervisor, service class registers and service class bit mask registers of the processor based on the mapping and the shift factor in response to configuration of the virtual shared cache by the VM.

16. The virtualized computer system of claim 15, wherein the configuring comprises:
trapping, by the hypervisor, access to the service class bit mask registers by the VM; and
trapping, by the hypervisor, access to the service class registers by the VM.

17. The virtualized computer system of claim 15, wherein the software is configured to:
determine, by the hypervisor, a size of the virtual shared cache for the VM based on a number of virtual central processing units (vCPUs) allocated to the VM.

18. The virtualized computer system of claim 17, wherein the software is configured to:
place, by the hypervisor, the virtual shared cache on the physical shared cache based on pinnings of the vCPUs to physical CPUs (pCPUs) of the processor.

19. The virtualized computer system of claim 18, wherein the software is configured to:
place, by the hypervisor, the virtual shared cache on the physical shared cache based on nonuniform memory access (NUMA) domains of the processor.

20. The virtualized computer system of claim 15, wherein the configuration of the virtual shared cache by the VM includes configuration of the virtual service class bit masks among the virtual service classes.
